(19) United States
(12) Patent Application Publication
(10) Pub. No.: US 2023/0370687 A1
(43) Pub. Date: Nov. 16, 2023

(54) METHOD AND SYSTEM FOR CREATING VIDEO HEAT MAPS

(71) Applicants: LAKSHMINATH REDDY DONDETI, San Jose, CA (US); VIDYA NARAYANAN, San Jose, CA (US)

(72) Inventors: LAKSHMINATH REDDY DONDETI, San Jose, CA (US); VIDYA NARAYANAN, San Jose, CA (US)

(21) Appl. No.: 18/197,035

(22) Filed: May 13, 2023

Related U.S. Application Data
(60) Provisional application No. 63/341,429, filed on May 13, 2022.

(51) Int. Cl. H04N 21/482; H04N 21/84

(52) U.S. Cl. CPC H04N 21/4826; H04N 21/84

(57) ABSTRACT

Exemplary embodiments of the present disclosure are directed towards system and method for creating video heat maps, comprising a computing device comprises a user engagement data collecting module configured to collect user engagement data with time stamps when the user creates the video content and viewing video content, the video creating module configured to transfer the collected user engagement data to the server. The server comprising a user engagement data analyzing module configured to analyze the collected user engagement data and generate the heat maps based on the analyzed user engagement data. The user engagement data analyzing module configured to transfer the generated heat maps to the computing device. The user engagement data collecting module configured to display the heat maps as a heat map bar and the user performed actions with icons.

### CROSS-REFERENCE TO RELATED APPLICATIONS

This patent application claims priority benefit of U.S. Provisional Patent Application No. 63/341,429, entitled “METHOD AND APPARATUS FOR CREATING HEAT MAPS”, filed on 13 May 2022. The entire contents of the patent application are hereby incorporated by reference herein in its entirety.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The present invention relates to providing an engagement Heat map on every video on the feed, which visually communicates the user-driven engagements happening during the entire duration of the video. The Heat map can be a colorful visualization that is a much faster way to contextualize aggregate user engagement for a given video. It gives viewers a useful impression of what works well on a video and can help guide them to create exciting content. Viewers receive a snapshot of how other viewers are engaging with the video. The Heat map indicates the relative concentration of engagement at various times during the runtime of the video.

### BACKGROUND

In recent years, streaming media has gained widespread popularity, with users consuming video content across various platforms, including social networking sites, professional content platforms, and commercial content created by brands and companies. However, existing short video platforms provide limited engagement metrics for users, as viewers can only view the total count of engagement metrics on a particular video without associating them with specific segments of the video. Furthermore, viewers may skip videos if they find the first few seconds unengaging, which could cause them to miss out on potentially exciting content towards the end. This presents a challenge for new content creators who wish to identify the specific creative aspects of a video responsible for generating high levels of engagement from viewers on other short video platforms.

In the light of the aforementioned discussion, there exists a need for a certain system and method for creating heat maps based on viewer engagement data with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a method and system for creating heat maps.

Another objective of the present disclosure is directed towards analyzing user engagement with video content by identifying the specific creative aspects of the video.

Another objective of the present disclosure is directed towards generating heat maps based on the video content with far less effort.

Another objective of the present disclosure is directed towards enabling the user to select a story/script on the computing device to create automated transition videos.

Another objective of the present disclosure is directed towards a system that detects inflection points in the music track.

Another objective of the present disclosure is directed towards a system that detects story/script inflection points.

Another objective of the present disclosure is directed towards a system that enables transitions at the inflection points.

Another objective of the present disclosure is directed towards a system that focuses on providing engagement metrics to viewers and content creators.

Another objective of the present disclosure is directed towards a system that allows viewers to identify the specific segments of the video that generated high levels of engagement.

Another objective of the present disclosure is directed towards a system that enables content creators to adjust their content accordingly to maximize engagement.

Another objective of the present disclosure is directed towards a system that analyzes viewer behavior, and engagement metrics and provides insights into viewer preferences and interests.

Another objective of the present disclosure is directed towards a system that provides viewer behavior information to content creators to develop targeted content that is tailored to their viewer's interests.

Another objective of the present disclosure is directed towards enabling the user to create new videos.

Another objective of the present disclosure is directed towards a system that aggregates user engagement of the individual user.

Another objective of the present disclosure is directed towards a system that displays a heat map of the video content on the computing device.

Another objective of the present disclosure is directed towards displaying a graphical representation of the engagement data.

Another objective of the present disclosure is directed towards displaying a heat map bar on a computing device.

Another objective of the present disclosure is directed towards a system that organizes the music tracks to mark specific points for transitions.

Another objective of the present disclosure is directed towards a system that allows the user to mark their custom transition points on the audio track before recording the transition videos.

Another objective of the present disclosure is directed towards a system that allows the user to mark their custom transition points on the audio track after recording the video.

According to an exemplary aspect of the present disclosure, enabling a user to login into a user engagement data collecting module by providing user credentials.

According to another exemplary aspect of the present disclosure, enables the user to access a special icon to create videos and view available videos after successful user login.

According to another exemplary aspect of the present disclosure, collecting user engagement data with time stamps when the user creates the video content and views video content by the user engagement data collecting module.

According to another exemplary aspect of the present disclosure, transferring collected user engagement data to a server by the user engagement data collecting module over a network.

According to another exemplary aspect of the present disclosure, receiving the collected user engagement data from the user engagement data collecting module by a user engagement data analyzing module enabled in the server.

According to another exemplary aspect of the present disclosure, analyzing the user engagement data by the user engagement data analyzing module.

According to another exemplary aspect of the present disclosure, generating the heat maps based on the analyzed user engagement data by the user engagement data analyzing module.

According to another exemplary aspect of the present disclosure, transferring the generated heat maps to the computing device by the user engagement data analyzing module over the network.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system for creating heat maps, in accordance with one or more exemplary embodiments.

FIG. 2 is a block diagram depicting an embodiment of the user engagement data collecting module 114 on the computing device, in accordance with one or more exemplary embodiments.

FIG. 3 is a block diagram depicting an embodiment of the user engagement data analyzing module 116 on server 106, in accordance with one or more exemplary embodiments.

FIG. 4 is a flow diagram depicting a method for creating video heat maps, in accordance with one or more exemplary embodiments.

FIG. 5 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

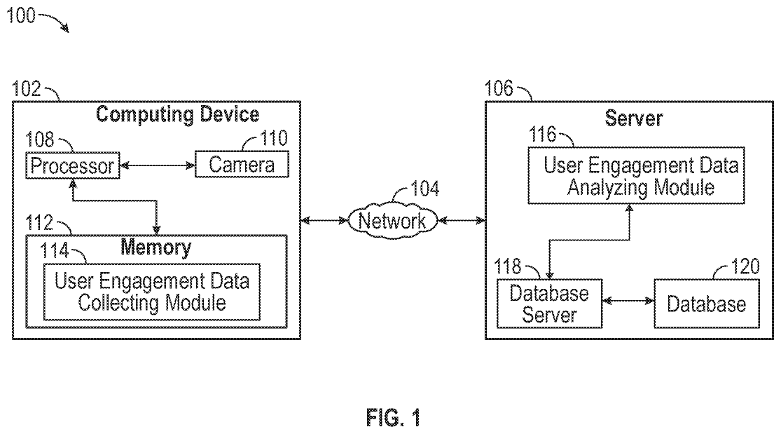

Referring to FIG. 1 is a block diagram 100 depicting a schematic representation of a system for creating video heat maps, in accordance with one or more exemplary embodiments. The system may be configured to track and understand user (for ex: viewer) behavior while watch videos hosted by another user. Here another user may be a client. The system 100 includes a computing device 102, a network 104, a server 106, a processor 108, a camera 110, a memory 112, a user engagement data collecting module 114, a user engagement data analyzing module 116, a database server 118, and a database 120.

The computing device 102 may include user device. The computing device 102 may include, but is not limited to, a personal digital assistant, smartphones, personal computers, a mobile station, computing tablets, a handheld device, an internet enabled calling device, an internet enabled calling software, a telephone, a mobile phone, a digital processing system, and so forth. The computing devices 102 may include the processor 108 in communication with a memory 112. The processor 108 may be a central processing unit. The memory 112 is a combination of flash memory and random-access memory.

The computing device 102 may be communicatively connected to the server 106 via the network 104. The network 104 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure.

Although the computing device 102 is shown in FIG. 1, an embodiment of the system 100 may support any number of computing devices. The computing device 102 may be operated by the user. The user may include, but not limited to, an individual, a client, an operator, a content creator, and the like. The computing device 102 supported by the system 100 is realized as a computer-implemented or computer-based device having the hardware or firmware, software, and/or processing logic needed to carry out the computer-implemented methodologies described in more detail herein.

In accordance with one or more exemplary embodiments of the present disclosure, the computing device 102 includes the camera 110 may be configured to enable the user to capture the multimedia objects using the processor 108. The multimedia objects may include, but not limited to short videos, videos, looping videos, and the like. The computing devices 102 may include the user engagement data collecting module 114 in the memory 112.

The user engagement data collecting module 114 may be configured to enable the user to view the videos on the computing device. The user engagement data collecting module 114 may be configured to collect the data about users (for ex: viewers) engage with videos by identifying parts of a video that they (users) re-watch, pause, skip, track. The user engagement data collecting module 114 may be configured to collect the data about user selected music tracks, selected script on the computing device. The user engagement data collecting module may also be configured to enable the user to select music tracks on the computing device 102 to create a video with transitions. The user engagement data collecting module 114 may also be configured to enable the user to create or record video segments or upload pre-recorded video segments or photos on the computing device. The user engagement data collecting module 114 may be any suitable applications downloaded from GOOGLE PLAY® (for Google Android devices), Apple Inc.'s APP STORE® (for Apple devices), or any other suitable database. The user engagement data collecting module 114 may be desktop application which runs on Windows or Linux or any other operating system and may be downloaded from a webpage or a CD/USB stick etc. In some embodiments, the user engagement data collecting module 114 may be software, firmware, or hardware that is integrated into the computing device 102. The computing devices 102 may present a web page to the user by way of a browser, wherein the webpage comprises a hyper-link may direct the user to uniform resource locator (URL).

The server 106 may include a user engagement data analyzing module 116, a database server 118, and a database 120. The user engagement data analyzing module 116 may be configured to generate heat maps by analyzing collected user engagement data. The collected user engagement data includes metadata, user selected music track, user selected music track, video transition points. The user engagement data analyzing module 116 may be configured to detect inflection points on the music track. The user engagement data analyzing module 116 may also be configured to provide start and stops points corresponding to the transition points on the music track and story to create automated transition videos. The user engagement data analyzing module 116 may also be configured to provide server-side functionality via the network 104 to one or more users. The database server 118 may be configured to access the one or more databases. The database 120 may be configured to store generated heat maps. The database 120 may also be configured to store interactions between the modules of the user engagement data collecting module 114 and the user engagement data analyzing module 116.

In accordance with one or more exemplary embodiments of the present disclosure, the computing device 102 may be configured to establish communication with the server 106 over the network 104. The computing device 102 may include the user engagement data collecting module 114. The user engagement data collecting module 114 may be configured to enable the user to access a special icon, thereby redirecting the user to a track screen and displaying music track library to the user on the track screen. The video user engagement data collecting module 114 may be configured to allow the user to access and select a music track from the music track library. The user engagement data collecting module 114 may be configured to allow the user to access and select script from the script library. The user engagement data collecting module 114 may be configured to transfer the user selected music track to the server 106 over the network 104. The user engagement data analyzing module 116 may be receive the user engagement data with video content. The user engagement data analyzing module 116 may be configured to perform audio analysis on the user selected music track and detect one or more inflection points, thereby assigning one or more transition points to the user selected music track based on the one or more detected inflection points. The user engagement data analyzing module 116 may be configured to generate one or more start and stop points corresponding to the one or more transition points on the user selected music track. The user engagement data analyzing module may be configured to analyze the generated one or more start and stop points for selected music tracks. The user engagement data analyzing module may also be configured to transfer the transition points corresponding to selected music tracks to the computing device for creating the videos. The user engagement data analyzing module may be configured to analyze user engagement data to create video create heat maps. The user engagement data analyzing module may be configured to create and transfer video heat maps (or heat maps) based on the analyzed data. The user engagement data collecting module 114 may be configured to receive heat maps based on the user engagement data and display the heat maps to the user on the computing device 102.

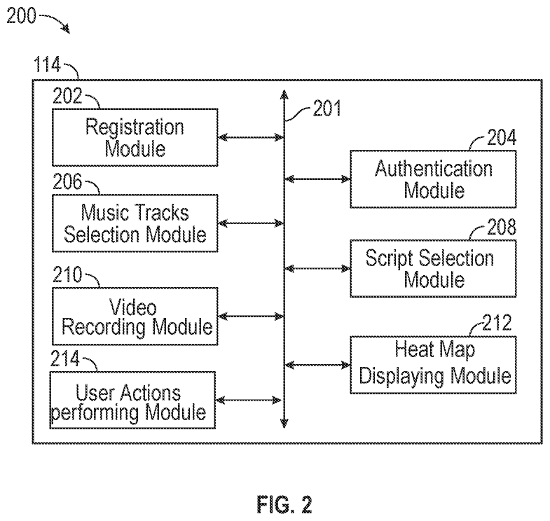

Referring to FIG. 2 is a block diagram 200 depicting an embodiment of the user engagement data collecting module 114 on the computing device 102, in accordance with one or more exemplary embodiments. The user engagement data collecting module 114 includes a bus 201, a registration module 202, an authentication module 204, a music tracks selection module 206, a script selection module 208, a video recording module 210, a user actions performing module 212, and heat map displaying module 214. The bus 201 may include a path that permits communication among the modules of the user engagement data colleting module 114 installed on the computing device 102. The term “module” is used broadly herein and refers generally to a program resident in the memory 112 of the computing device 102.

The registration module 202 may be configured to enable the user to register on the user engagement data collecting module 114 installed on the computing device 102 by providing basic details of the user. The basic details may include but not limited to email, password, first and last name, phone number, address details, and the like. The registration module 202 may also be configured to transfer the user registration details to the server 106 over the network 104. The server 106 may include the user engagement data analyzing module 116. The user engagement data analyzing module 116 may be configured to receive the user registration details from the registration module 202. The authentication module 204 may be configured to enable the user to log in and access the user engagement data analyzing module 114 installed on the computing device 102 by using the user login identity credentials. The music tracks selection module 206 may be configured to display the available music tracks on the track screen to the user. The available music tracks may include but not limited to templates of particular videos. The music tracks selection module 206 may also be configured to enable the user to access the music tracks from third-party applications. The music tracks selection module 206 may also be configured to transfer the user selected music track to the server 106 over the network 104. The script selection module 208 may be configured to display the available scripts on the track screen to the user. The available scripts may include but not limited to soundtracks of the particular videos. The script selection module 208 may also be configured to enable the user to access the scripts from the third-party applications. The music tracks selection module 206 and the script selection module 208 may also be configured to allow the user to access and select the music track and the scripts for creating or recording video segments. The server 106 may include the user engagement data analyzing module 116. The user engagement data analyzing module 116 may be configured to receive the user selected music track and selected script. Here script may be a story, content.

The video recording module 210 may be configured to enable the user to tap a camera icon on the computing device 102 to record the video segments using the music tracks and scripts. The video recording module 210 may also be configured to enable the user to upload pre-recorded videos on the computing device 102. The video recording module 210 may also be configured to enable the user to upload the videos stored from the memory 112 of the computing device 102. The video recording module 210 may also be configured to display the start and stop points of the music track to the user. The video recording module 210 may also be configured to enable the user to record video segments at the start and stop points of the music track. The video recording module 210 may also be configured to enable the user to record video segments using available scripts. The video recording module 208 may also be configured to transfer the user recorded video segments to the server 106. The video recording module 208 may also be configured to allow the user to record the complete scene corresponding to the entire track duration multiple times. The video recording module 208 may also be configured to enable the user to create transition videos. The user actions performing module 216 may also be configured to enable the user to perform actions while watching a video. The user perform actions may include, but not limited to like the video, share the video on social platforms, click award icon on social platforms, repeat the particular segment of the video content while watching, skip particular segment of the video content, pause the video content at particular point, and track the video at particular point. The user perform actions may be user engagement with video content. The user actions performing module may also be configured to send performed user actions with time stamps to the server.

The heat map displaying module 212 may be configured to receive heat map with video content based on the user interactions of the individual users. Here users may be viewers. Heat maps may be graphical representation of the user engagement data with video content, which may be typically used to visualize the areas of a website or application that are mostly clicked or interacted with. In the case of video content, a heat map may be used to show which parts of the video are viewed the most by users, or which sections of the video are most frequently replayed. By receiving the generated heat maps from individual users' interactions. The heat map displaying module 212 may be configured to provide valuable insights into how users are engaging with video content or the overall experience. The heat map displaying module 212 may also be configured to represent the engagement and heat maps with special icons. These special icon may be displayed above a heat map bar on the computing device. The special icons may include, but not limited to like icon, share icon, award icon, camera icon, sound track icon, audio video inflection points icon. In accordance to the one or more exemplary embodiments, engagement intensity may be represented with different special icons. The different special icons may be mapped with different colors onto the heat map bar with various opacities based on the relative intensity of engagement happening on a particular point of a video. The actual engagement representations with special icons may be displayed above the heat map bar to communicate actual happening. The special icons may be animated icons. The heat map displaying module may be representative usernames, user profile photos, or both indicating. In accordance to the exemplary embodiment, the special icons may be represented different user-driven engagements. The special icons may be represented on the engagement heat map includes likes, awards, social shares, new video creation using the template of a particular video, new video creation using a soundtrack of a particular video, transitions, music inflection points, story/script inflection points, usage of any visual effects, usage of any sound effects.

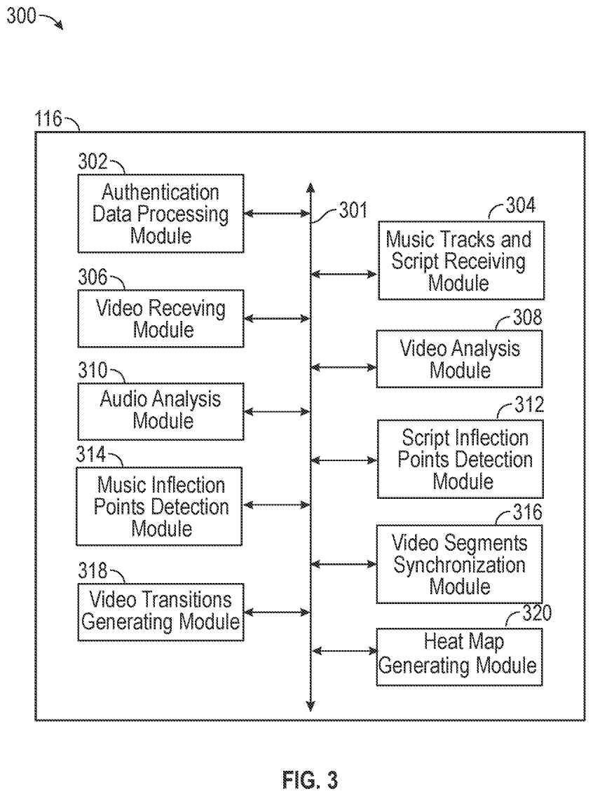

Referring to FIG. 3 is a block diagram depicting an embodiment of the user engagement data analyzing module 116 on the server 106, in accordance with one or more exemplary embodiments. The user engagement data analyzing module 116 include a bus 301, an authentication data processing module 302, a music tracks and script receiving module 304, a video receiving module 306, a video analysis module 308, an audio analysis module 310, a script inflection points detection module 312, a music track inflection points 314, a video segments synchronization module 316, a video transitions generating module 318, a heat map generating module 320. The bus 301 may include a path that permits communication among the modules of the user engagement data analyzing module 116 installed on the server 106.

The authentication data processing module 302 may be configured to receive the user registration details from the registration module 202. The authentication data processing module 302 may also be configured to generate the user login identity credentials using the user registration details. The identity credentials comprise a unique identifier (e.g., a username, an email address, a date of birth, a house address, a mobile number, and the like), and a secured code (e.g., a password, a symmetric encryption key, biometric values, a passphrase, and the like). The music tracks and script receiving module 304 may be configured to receive the user selected music track and selected script from the music tracks selection module 206 and the script selection module 208. The audio analysis module 310 may be configured to perform the audio analysis on the user selected music track and detects the changes in the user selected music track. The changes may include but not limited to pace, energy, volume, fusion tracks, and the like. The music track inflection points detection module 314 may be configured to detect inflection points based on the changes in pace, energy, volume, and fusion tracks of the user selected music track. The script inflection points detection module 312 may be configured to detect inflection points based on the decisive changes of the user selected the script.

The video receiving module 306 may be configured to receive the user recorded video segments from the video recording module 204. The video analysis module 308 may be configured to analyze the user recorded video segments to detect objects and points from the user recorded video segments. The video segments synchronization module 316 may be configured to synchronize the user recorded video segments based on the detected objects and points from the user recorded video segments. The video transitions generating module 318 may be configured to stitch the right portions from each video segment to create a transition video. The heat map generating module 320 may be configured to receive detected user actions from the user actions performing module 214, detected music inflection points from the music inflection points detection module 314, detected script inflection points from script inflection points detection module 312, generated transition videos from the video transitions generating module 318, user authentication details from the authentication data processing module 302. The heat map generating module 320 may be configured to analyze the received data from sub modules of the user engagement data collecting module 114 and the user engagement data analyzing module 116. The heat map generating module 320 may be configured to generate heat maps based on the analyzed the user engagement data with video content. The heat map generating module 320 may also be configured to generate heat maps bar and user performed actions icons. The user performed actions icons may be represented user-driven engagements. The user-driven engagements may include, but not limited to like the video, share the video on social platforms, click award on social platforms, repeat the particular segment of the video content while watching, skip particular segment of the video content, pause the video content at particular point, and track the video at particular point. The heat map generating module 320 may be configured to send the generated heat map to the user engagement data collecting module over the network 104. The heat map may include but not limited to heat map bar, user performed actions with icons and the like.

In accordance to the exemplary embodiment, the user engagement data collecting module 114 may be configured to collect the video creation data with time stamps when user creating the video. Here video creation data may be referred to user engagement data. The video creation data may include, but not limited to hashtags, visual effects, characters, scenes, sound effects. The user engagement data collecting module 114 may be configured to collected video creation data to the server, The server include the user engagement data collecting module may be configured to receive the collected video creation data. The user engagement data collecting module may be configured may be configured to analyze the receive the collected video creation data and also user engagement data. The user engagement data collecting module may be configured to generate the heat maps based on the analyzed data. The user engagement data collecting module may be configured to transfer the generated the heat maps to the computing device 102. The computing device 102 includes heat map displaying module may be configured to enable the user to access the generated heat maps. The heat map displaying module may be configured to display generated heat maps as heat map bar and represent user performing actions with icons.

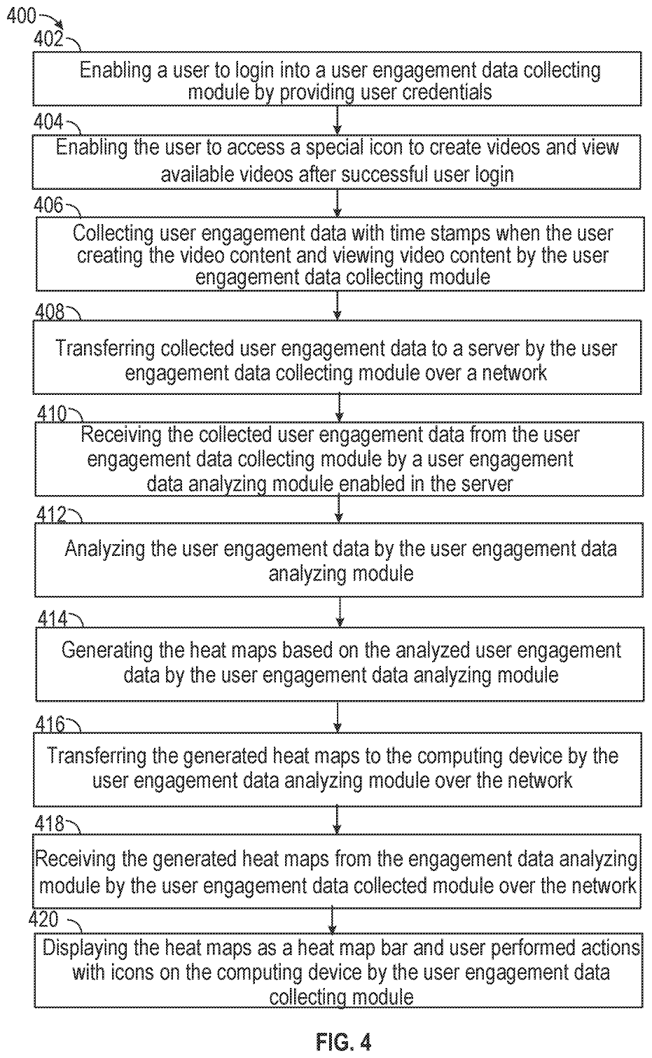

Referring to FIG. 4 is a flow diagram 400 depicting a method for creating heat maps, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method commences at step 402, enabling a user to login into a user engagement data collecting module by providing user credentials. Thereafter at step 404, enabling the user to access a special icon to create videos and view available videos after successful user login. Thereafter at step 406, collecting user engagement data with time stamps when user creating the video or viewing video by the user engagement data collecting module. Thereafter at step 408, transferring collected user engagement data on the video content to a server by the user engagement data collecting module over a network. Thereafter at step 410, receiving the collected user engagement data on the video content by a user engagement data analyzing module. Thereafter at step 412, analyzing the user engagement data by the user engagement data by the user engagement data analyzing module. Thereafter at step 414, generating the heat maps based on the analyzed user engagement data by the user engagement data analyzing module. Thereafter at step 416, transferring the generated heat maps to the computing device by the user engagement data analyzing module over the network. Thereafter at step 418, receiving the generated heat maps from the engagement data analyzing module by the user engagement data collected module over the network. Thereafter at step 420, displaying the heat maps as a heat map bar with user performed actions on the computing device by the user engagement data collecting module.

In accordance with one or more exemplary embodiments, the user actions performing module 214 may be configured to perform user engagement with video content. Here user engagement may include but not limited to user interaction with video content. The user actions performing module 214 may be configured to enable the user to perform one or more actions while viewing video content. The one or more actions may include, but not limited to repeat a particular segment/frame of the video, skip a particular segment/frame of the video, pause the video at particular point of time. The user engagement while user creating the video, the user endearment data collecting module may be configured to enable the user to select a script from templates, select a music from the templates. The user engagement data collecting module 114 may be configured to enable the user to select any visual effect and sound effect from the visual effect library and sound effect library, and also the select from third-part applications. The engagement data collecting module 114 comprises a script selection module 208 may be configured to enable the user to access and select a script from one or more pre-designed templates. The engagement data collecting module includes a music selection module 206 may be configured to enable the user to access and select a music track from one or more pre-designed templates. The user actions performing module 214 may be configured to transfer the user engagement with time stamp to the server 106. The script selection module 208 and the music track selection module 206 may be configured to transfer user selected script and music track to the server.

The server 106 includes a video analysis module 308 may be configured to receive user engagement with video content from the user actions performing module 214. The music tracks and script receiving module 304 may be configured to receive the user selected script and user selected music track from the script selection module 208 and the music track selection module. The script inflection points detection module 312 may be configured to detect script inflection points on detected changes in the user selected script. The music inflection points detection module 314 may be configured to detect music inflection points on detected changes in the user selected music track. The video transitions generating module 318 may be configured to generate transitions videos based on the detected one or more script inflection points and one or more music inflection points. The heat map generating module 320 may be configured to receive the generated transitions, detected script inflection points, detected music inflection points, detected user performed actions from the video transitions generating module 318, the script inflection points detection module 312, the music inflection points detection module 314, a video analysis module 308. The heat map generating module 320 may be configured to generate heat maps based on received generated transitions, detected script inflection points, detected music inflection points, detected user performed actions, whereby the heat map generating module 320 may be configured to the heat map displaying module on the computing device 102. The heat map displaying module 320 may be configured to enable the user to view and access valuable insights for user engaging with video content. The user may include but not limited to a viewer and content creator. Enabling content creator to improve the video content based on accessed valuable insights.

In other one or more exemplary embodiments, the system may be configured to enable the user to communicate the different duration points of the video where users can observe inflection points belonging to Audio & Video. Audio/Video inflection points mapped on the Heat map indeed system driven engagements.

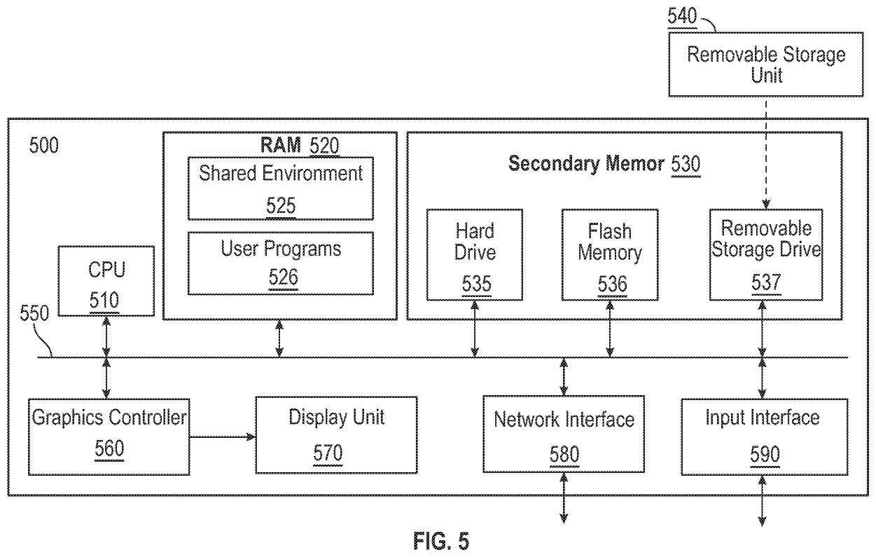

Referring to FIG. 5 is a block diagram 500 illustrating the details of a digital processing system 500 in which various aspects of the present disclosure are operative by execution of appropriate software instructions. The Digital processing system 500 may correspond to the computing device 102 (or any other system in which the various features disclosed above can be implemented).

Digital processing system 500 may contain one or more processors such as a central processing unit (CPU) 510, random access memory (RAM) 520, secondary memory 530, graphics controller 560, display unit 570, network interface 580, and input interface 590. All the components except display unit 570 may communicate with each other over communication path 550, which may contain several buses as is well known in the relevant arts. The components of FIG. 5 are described below in further detail.

CPU 510 may execute instructions stored in RAM 520 to provide several features of the present disclosure. CPU 510 may contain multiple processing units, with each processing unit potentially being designed for a specific task. Alternatively, CPU 510 may contain only a single general-purpose processing unit.

RAM 520 may receive instructions from secondary memory 530 using communication path 550. RAM 520 is shown currently containing software instructions, such as those used in threads and stacks, constituting shared environment 525 and/or user programs 526. Shared environment 525 includes operating systems, device drivers, virtual machines, etc., which provide a (common) run time environment for execution of user programs 526.

Graphics controller 560 generates display signals (e.g., in RGB format) to display unit 570 based on data/instructions received from CPU 510. Display unit 570 contains a display screen to display the images defined by the display signals. Input interface 590 may correspond to a keyboard and a pointing device (e.g., touch-pad, mouse) and may be used to provide inputs. Network interface 580 provides connectivity to a network (e.g., using Internet Protocol), and may be used to communicate with other systems (such as those shown in FIG. 1) connected to the network 104.

Secondary memory 530 may contain hard drive 535, flash memory 536, and removable storage drive 537. Secondary memory 530 may store the data software instructions (e.g., for performing the actions noted above with respect to the Figures), which enable digital processing system 500 to provide several features in accordance with the present disclosure.

Some or all of the data and instructions may be provided on removable storage unit 540, and the data and instructions may be read and provided by removable storage drive 537 to CPU 510. Floppy drive, magnetic tape drive, CD-ROM drive, DVD Drive, Flash memory, removable memory chip (PCMCIA Card, EEPROM) are examples of such removable storage drive 537.

Removable storage unit 540 may be implemented using medium and storage format compatible with removable storage drive 537 such that removable storage drive 537 can read the data and instructions. Thus, removable storage unit 540 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 540 or hard disk installed in hard drive 535. These computer program products are means for providing software to digital processing system 500. CPU 510 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 530. Volatile media includes dynamic memory, such as RAM 520. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 550. Transmission media can also take the form of acoustic or light waves, such as those generated during radio-wave and infra-red data communications.

According to an exemplary aspect of the present disclosure, enabling a user to login into a user engagement data collecting module 114 by providing user credentials.

According to an exemplary aspect of the present disclosure, enabling the user to access a special icon to create videos and view available videos after successful user login.

According to an exemplary aspect of the present disclosure, collecting user engagement data with time stamps when the user creating the video content and viewing video content by the user engagement data collecting module 114.

According to an exemplary aspect of the present disclosure, transferring collected user engagement data to a server by the user engagement data collecting module over a network 104.

According to an exemplary aspect of the present disclosure, receiving the collected user engagement data from the user engagement data collecting module 114 by a user engagement data analyzing module 116 enabled in the server 106.

According to an exemplary aspect of the present disclosure, analyzing the user engagement data by the user engagement data analyzing module 116.

According to an exemplary aspect of the present disclosure, generating the heat maps based on the analyzed user engagement data by the user engagement data analyzing module 116.

According to an exemplary aspect of the present disclosure, transferring the generated heat maps to the computing device 102 by the user engagement data analyzing module 116 over the network 106.

According to an exemplary aspect of the present disclosure, receiving the generated heat maps from the engagement data analyzing module 116 by the user engagement data collected module 116 over the network 106.

According to an exemplary aspect of the present disclosure, displaying the heat maps as a heat map bar and user performed actions with icons on the computing device by the user engagement data collecting module 114.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A method for creating video heat maps, comprising:
enabling a user to login into a user engagement data collecting module by providing user credentials;
enabling the user to access a special icon to create videos and view available videos after successful user login;
collecting user engagement data with time stamps when the user creates the video content and views video content by the user engagement data collecting module;
transferring collected user engagement data to a server by the user engagement data collecting module over a network;
receiving the collected user engagement data from the user engagement data collecting module by a user engagement data analyzing module enabled in the server;
analyzing the user engagement data by the user engagement data analyzing module;
generating the heat maps based on the analyzed user engagement data by the user engagement data analyzing module;
transferring the generated heat maps to the computing device by the user engagement data analyzing module over the network;
receiving the generated heat maps from the engagement data analyzing module by the user engagement data collected module over the network; and
displaying the heat maps as a heat map bar and the user performed actions with icons on the computing device by the user engagement data collecting module.

2. The method of claim 1, comprising a step of performing user engagement during viewing the video at least one of: repeating a particular segment of the video, skipping a particular segment of the video, pausing the video at a particular point in time by the user actions performing module.

3. The method of claim 1, a step of collecting video creation data with time stamps when the video is created by the user engagement data collecting module,

4. The method of claim 3, wherein the video creation data comprises hashtags, visual effects, characters, scenes, sound effects.

5. The method of claim 1, comprising a step of allowing the user to access and select a script and a music track from one or more pre-designed templates by a script selection module and a music selection module.

6. The method of claim 1, comprising a step of transferring the user engagement and video creation data with a time stamp to the server by the user actions performing module.

7. The method of claim 1, comprising a step of transferring user selected script and music track to the server by the script selection module and the music track selection module.

8. The method of claim 1, comprising a step of receiving user engagement data and the video creation data with time stamps from the user actions performing module by a video analysis module.

9. The method of claim 1, comprising a step of receiving the user selected script and user selected music track from the script selection module and the music track selection module by a music tracks and script receiving module.

10. The method of claim 1, comprising a step of detecting one or more script inflection points on detected changes in the user selected script by a script inflection points detection module.

11. The method of claim 1, comprising a step of detecting one or more music inflection points on detected changes in the user selected music track by a music inflection points detection module.

12. The method of claim 1, comprising a step of generating transition videos based on the one or more detected script inflection points, one or more detected music inflection points and video creation data by a video transition generating module.

13. The method of claim 1, comprising a step of receiving the generated transitions, detected script inflection points, detected music inflection points, detected user performed actions from the video transitions generating module, the story inflection points detection module, the music inflection points detection module, a video analysis module by a heat map generating module.

14. The method of claim 1, comprising a step of generating heat maps based on received generated transitions, detected script inflection points, detected music inflection points, and detected user performed actions by the heat map generating module.

15. The method of claim 1, comprising a step of transferring generated heat maps to the computing device by the heat map generating module over the network.

16. The method of claim 1, comprising a step of receiving generated heat maps from the heat map generating module by a heat map displaying module.

17. The method of claim 1, comprising a step of enabling the user to access valuable insights for user engaging with video content by the heat map displaying module.

18. The method of claim 1, comprising a step of enabling the user to improve the video content based on accessed valuable insights.

19. A system for creating video heat maps, comprising:
a computing device configured to establish communication with a server over a network, whereby the computing device comprises a user engagement data collecting module configured to enable a user to log in by providing user credentials, thereby user engagement data collecting module configured to enable the user to access a special icon to create videos and view available videos after successful user login, the user engagement data collecting module configured to collect user engagement data with time stamps when the user creating the video content and viewing video content, the video creating module configured to transfer the collected user engagement data to the server over a network;
the server comprising a user engagement data analyzing module configured to receive the collected user engagement data from the user engagement data collecting module, whereby the user engagement data analyzing module configured to analyze the collected user engagement data;
the user engagement data analyzing module configured to generate the heat maps based on the analyzed user engagement data, whereby the user engagement data analyzing module configured to transfer the generated heat maps to the computing device over the network; and
the user engagement data collecting module is configured to receive the generated heat maps from the user engagement data analyzing module over the network, whereby the user engagement data collecting module configured to display the heat maps as a heat map bar and user performed actions with icons.

20. A computer program product comprising a non-transitory computer-readable medium having a computer-readable program code embodied therein to be executed by one or more processors, said program code including instructions to:
enable a user to login into a user engagement data collecting module by providing user credentials;
enable the user to access a special icon to create videos and view available videos after successful user login;
collect user engagement data with time stamps when the user creates the video content and views video content by the user engagement data collecting module;
transfer collected user engagement data to a server by the user engagement data collecting module over a network;
receive the collected user engagement data from the user engagement data collecting module by a user engagement data analyzing module enabled in the server
analyze the user engagement data by the user engagement data analyzing module;
generate the heat maps based on the analyzed user engagement data by the user engagement data analyzing module;
transfer the generated heat maps to the computing device by the user engagement data analyzing module over the network;
receive the generated heat maps from the engagement data analyzing module by the user engagement data collected module over the network; and
display the heat maps as a heat map bar with user-performed actions on the computing device by the user engagement data collecting module.
